(19) United States
(12) Patent Application Publication
(10) Pub. No.: US 2026/0115602 A1
(43) Pub. Date: Apr. 30, 2026

(54) SERVER DEVICE, INFORMATION PROCESSING DEVICE, AND METHOD OF DETERMINING DATE AND TIME FOR EVENT

(71) Applicant: Sony Interactive Entertainment Inc., Tokyo (JP)

(72) Inventor: Nobuyuki Nakamura, Kanagawa (JP)

(73) Assignee: Sony Interactive Entertainment Inc., Tokyo (JP)

(21) Appl. No.: 19/431,841

(22) Filed: Dec. 23, 2025

Related U.S. Application Data
(63) Continuation of application No. PCT/JP2023/024567, filed on Jul. 3, 2023.

(51) Int. Cl. A63F 13/79; A63F 13/35

(52) U.S. Cl. CPC A63F 13/79; A63F 13/35

(57) ABSTRACT

An event participation ratio deriving section derives participation ratios of events in the past on the basis of the number of players that have registered for the events in the past and the number of players that have actually participated in the events in the past. An event determining section determines dates and times for holding events in the future on the basis of the participation ratios of the events in the past.

This application is a Continuation Application under 35 U.S.C. 111 of International Patent Application No. PCT/JP2023/024567, filed on July 3, 2023, the entire disclosure of which is incorporated herein by reference for all purposes.

### TECHNICAL FIELD

The present disclosure relates to a technology for supporting holding of an event such as a game tournament.

### BACKGROUND

Popularity of e-sports has been rising all over the world. Recent years have seen prize-giving game tournaments that are periodically held by game publishers and game developers with a view to making games more popular. An event organizer plans a game tournament with details including dates and times for holding the game tournament and a match format, and invites players to take part in the game tournament. The players register to participate in the game tournament during an application period and then check in at the game tournament at the dates and times of their matches. The participating players can acquire rewards or prizes by performing well in the game tournament.

### SUMMARY

The longer the period after a player registered to participate becomes until they check in, i.e., take part in, at the game tournament, the higher the possibility for the player to forget that they have registered their participation in the game tournament and to cancel their participation in the game tournament is. After the end of the application period, the event organizer prepares a list of matches, i.e., a tournament bracket. If there are many no-shows, i.e., cancellations, occurring in the tournament bracket, then many players earn byes on account of the absent opponents. When this happens, the event organizer finds it problematic because investment efficiency is reduced due to a low player participation ratio despite having prepared the prizes for the game tournament. For this reason, there have been demands for a scheme for efficiently holding events such as game tournaments.

A server device according to an aspect of the present disclosure includes one or more processors having hardware. The one or more processors derive participation ratios of past events based on numbers of players that registered for the past events and numbers of players that actually participated in the past events, and determine one or more dates and times for future events based on the participation ratios of the past events.

An information processing device according to another aspect of the present disclosure includes one or more processors having hardware. The one or more processors acquire an event list generated based on participation ratios of a user in past events, and display the acquired event list.

A method according to another aspect of the disclosure refers to a method of determining date and time for an event, the method including a step of deriving participation ratios of past events based on numbers of players that registered for the past events and numbers of players that actually participated in the past events, and a step of determining one or more dates and times for future events based on the participation ratios of the past events.

Any combinations of the above components and expressions of the present disclosure as converted between methods, devices, systems, recording media, and computer programs are also effective as aspects of the present disclosure.

### BRIEF DESCRIPTION OF THE DRAWINGS

FIG. 1 is a diagram illustrating an information processing system according to an embodiment.

FIG. 2 is a diagram illustrating a hardware configuration of an information processing device.

FIG. 3 is a diagram illustrating functional blocks of the information processing device.

FIG. 4 is a diagram illustrating an event selection screen by way of example.

FIG. 5 is a diagram illustrating an event registration screen by way of example.

FIG. 6 is a diagram illustrating a registration completion screen by way of example.

FIG. 7 is a diagram illustrating a check-in screen by way of example.

FIG. 8 is a diagram illustrating a check-in completion screen by way of example.

FIG. 9 is a diagram illustrating functional blocks of a server device according to the embodiment.

FIG. 10 is a diagram illustrating participation ratios by way of example.

FIG. 11 is a diagram illustrating by way of example start times of events whose average participation ratios are high.

### DETAILED DESCRIPTION

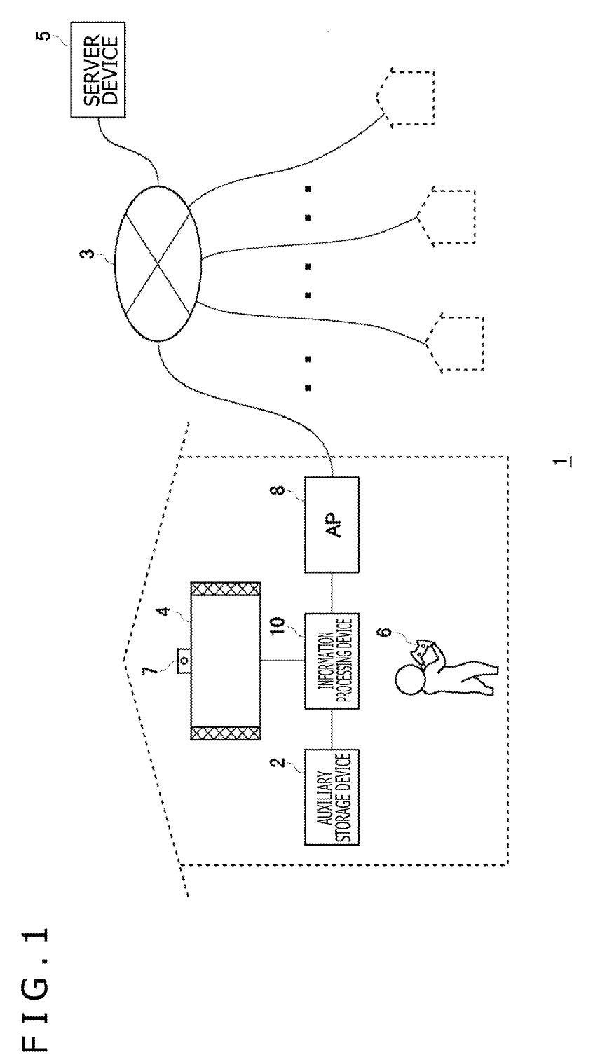

FIG. 1 illustrates an information processing system 1 according to an embodiment of the present disclosure. The information processing system 1 according to the embodiment represents a game system for assisting in holding an event such as a game tournament, and includes an information processing device 10 operated by a user and a server device 5. An access point (hereinafter referred to as an “AP”) 8 has functions of a wireless access point and a router. The information processing device 10 is connected to the AP 8 through a wireless or wired link so as to connect to the server device 5 on a network 3 for communication therewith. Though one user and one information processing device 10 are illustrated in FIG. 1, the information processing system 1 is premised on the assumption that it has a plurality of information processing devices 10 operated respectively by a plurality of users and connected to the server device 5 via the network 3.

The information processing device 10 is connected to an input device 6 operated by the user via a wireless or wired link. The input device 6 outputs information operated by the user to the information processing device 10. When the information processing device 10 accepts the operated information from the input device 6, the information processing device 10 reflects the operated information in the processing of system software or game software and outputs a processed result from an output device 4. In the information processing system 1, the information processing device 10 may be a game device (game console) for executing a game whereas the input device 6 may be a device such as a game controller for supplying operated information from the user to the information processing device 10. Note that the input device 6 may be an input interface such as a keyboard and a mouse.

An auxiliary storage device 2 is a large-capacity recording device such as an HDD (Hard Disk Drive) or an SSD (Solid-State Drive), and may be an internal recording device or an external recording device that can be connected to the information processing device 10 via a USB (Universal Serial Bus). The output device 4 may be a television having a display for outputting images and a speaker for outputting sounds. The output device 4 may be connected to the information processing device 10 by a cable or a wireless link.

A camera 7 as an image capturing device is provided in the vicinity of the output device 4 and captures images of a space around the output device 4. Though the camera 7 is illustrated as being mounted on an upper portion of the output device 4 by way of example, the camera 7 may be disposed on a side portion or a lower portion of the output device 4, and is located in either case at a position for capturing images of the user that is positioned in front of the output device 4. The camera 7 may be a stereo camera.

The server device 5 provides a network service to the users of the information processing system 1. The server device 5 manages network accounts (user accounts) that identify the respective users. Each of the users signs in at the network service provided by the server device 5 using its own network account. By signing in at the network service from the information processing device 10, the user can register in the server device 5 saved data of a game and trophies that are virtual rewards won while playing the game. The saved data and trophies that have been registered in the server device 5 can be synchronized even when the user uses other information processing devices than the information processing device 10.

The server device 5 according to the embodiment has a function to set events such as game tournaments. The server device 5 may have a function to at least determine a date and time at which to hold an event and notify the user of the holding of the event. The server 5 acquires requirements with regard to the holding of the event from an organizer of the event and determines a date and time at which to hold the event on the basis of the requirements. Note that the server device 5 may provide an event outsourcing service to the event organizer. According to the event outsourcing service, the server device 5 may carry out tasks from the setting of an event to the running of the event pursuant to instructions from the event organizer.

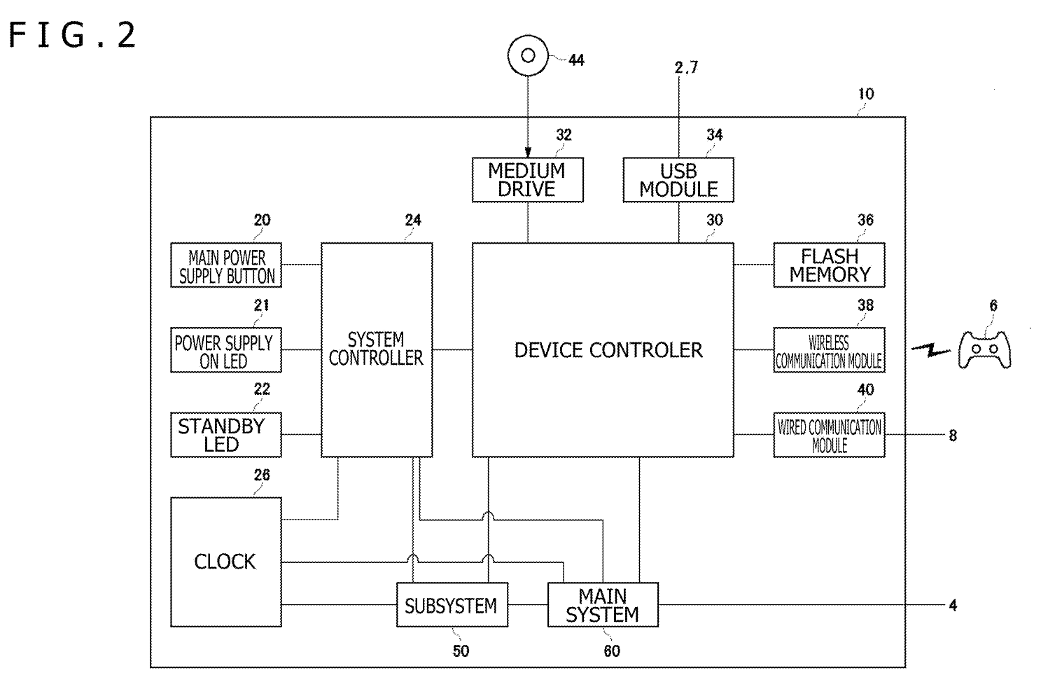

FIG. 2 illustrates a hardware configuration of the information processing device 10. The information processing device 10 has a main power supply button 20, a power supply ON LED (Light-Emitting Diode) 21, a standby LED 22, a system controller 24, a clock 26, a device controller 30, a medium drive 32, a USB module 34, a flash memory 36, a wireless communication module 38, a wired communication module 40, a subsystem 50, and a main system 60.

The main system 60 includes a main CPU (Central Processing Unit), a memory as a main storage device, a memory controller, and a GPU (Graphics Processing Unit). The GPU is used mainly for processing a game program. The main CPU has a function to activate system software and execute a game program installed in the auxiliary storage device 2 in the environment provided by the system software. The subsystem 50 includes a sub-CPU, a memory as a main storage device, a memory controller, and the like, and is free of a GPU.

Whereas the main CPU has the function to execute a game program installed in the auxiliary storage device 2, the sub-CPU lacks such function. However, the sub-CPU has a function to access the auxiliary storage device 2 and a function to send data to and receive data from the server device 5. Since the sub-CPU has only such limited processing functions, it can operate with smaller electric power consumption than that of the main CPU. These functions of the sub-CPU are performed while the main CPU is in a standby state.

The main power supply button 20 represents an input unit to which an operation input is applied by the user. The main power supply button 20 is provided on the front face of a casing of the information processing device 10, and is operated to turn on or off a power supply to the main system 60 of the information processing device 10. The power supply ON LED 21 is energized when the main power supply button 20 is turned on, and the standby LED 22 is energized when the main power supply button 20 is turned off. The system controller 24 detects when the user depresses the main power supply button 20.

The clock 26 is a real-time clock, and generates present day and time information and supplies the generated present day and time information to the system controller 24, the subsystem 50, and the main system 60.

The device controller 30 is implemented as an LSI (Large-Scale Integrated Circuit) that exchanges information between devices like a southbridge. As illustrated in FIG. 2, the devices that include the system controller 24, the medium drive 32, the USB module 34, the flash memory 36, the wireless communication module 38, the wired communication module 40, the subsystem 50, and the main system 60 are connected to the device controller 30. The device controller 30 absorbs the differences between the electric characteristics and data transfer rates of the devices and controls the timing of data transfer.

The medium drive 32 refers to a drive device for driving a ROM (Read-Only Memory) medium 44 inserted therein that is recording application software of a game and license information thereof and reading programs, data and the like from the ROM medium 44. The ROM medium 44 refers to a read-only recording medium such as an optical disk, a magnetooptical disk, or a Blu-ray disk.

The USB module 34 refers to a module for connection to an external module through a USB module. The USB module 34 may be connected to the auxiliary storage device 2 and the camera 7 by USB cables. The flash memory 36 refers to an auxiliary storage device as an internal storage. The wireless communication module 38 performs wireless communication with the input device 6 according to a communication protocol such as Bluetooth (registered trademark) or IEEE (Institute of Electrical and Electronics Engineers) 802.11 protocol. The wired communication module 40 that performs wired communication with an external device is connected to the network 3 via the AP 8.

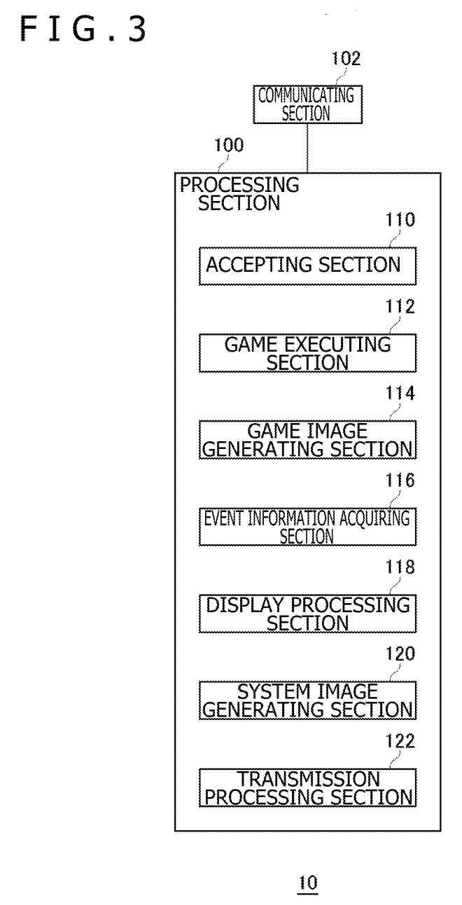

FIG. 3 illustrates functional blocks of the information processing device 10. The information processing device 10 includes a processing section 100 and a communicating section 102. The processing section 100 includes an accepting section 110, a game executing section 112, a game image generating section 114, an event information acquiring section 116, a display processing section 118, a system image generating section 120, and a transmission processing section 122. The accepting section 110 accepts operating information entered from the input device 6 that is operated by the user.

The information processing device 10 includes a computer that realizes the various functions illustrated in FIG. 3 by executing programs. The computer includes a memory for being loaded with the programs, one or more processors for executing the programs, an auxiliary storage device, other LSIs, and the like, as a hardware. The processor or processors are made up of a plurality of electronic circuits including semiconductor integrated circuits and LSIs. The electronic circuits may be mounted on one chip or a plurality of chips. The functional blocks illustrated in FIG. 3 are implemented by coordination between hardware and software, so that those skilled in the art is able to understand that these functional blocks can be implemented in various forms based on only hardware, only software, or their combination.

The game executing section 112 has a function to launch and execute a game program. The game executing section 112 performs a processing operation to move game characters in a virtual space on the basis of operating information accepted by the accepting section 110. The game image generating section 114 includes a GPU for performing a rendering process to generate game image data. The display processing section 118 displays generated game images on the output device 4. The processing section 100 includes a game sound generating section for generating game sound data, which is omitted from illustration in FIG. 3.

When the user operates a predetermined button on the input device 6, the system image generating section 120 generates a home image, and the display processing section 118 displays a home screen (not depicted) on the output device 4. When the user selects an “EVENT” icon on the home screen, the event information acquiring section 116 acquires a list of events that the user can take part in from the server device 5. The system image generating section 120 generates an event selection image including the acquired event list, and the display processing section 118 displays the event selection image on the output device 4.

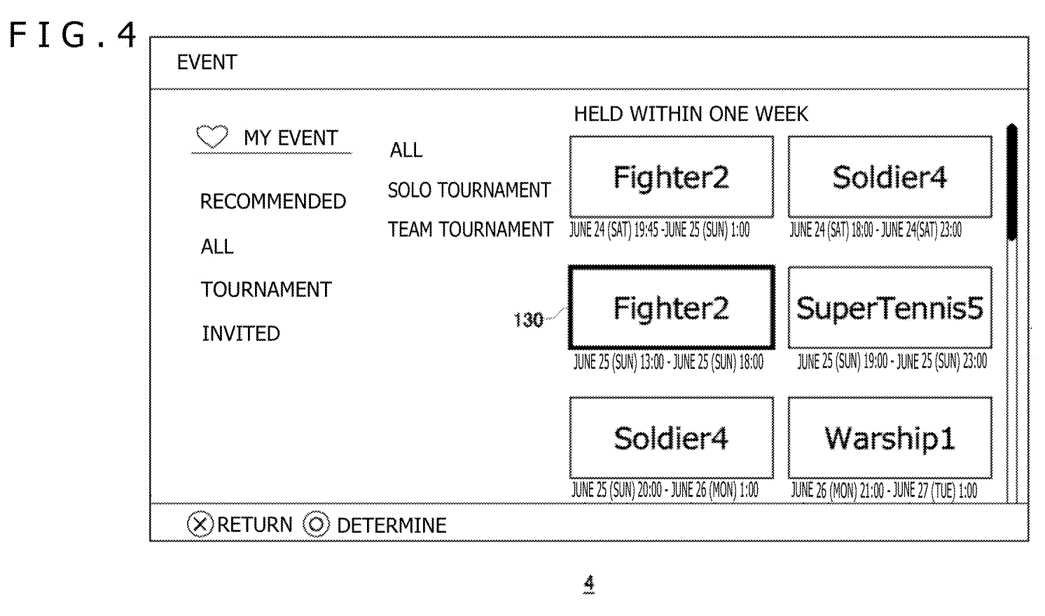

FIG. 4 illustrates an event selection screen by way of example. According to this example, a list of game tournaments to be held within one week categorized as “SOLO TOURNAMENT” that the user can take part in is displayed on the event selection screen. The user operates the input device 6 to align a focus frame 130 with the icon of an event that the user wishes to participate in. Here, a game tournament entitled “Fighter2” to be held at 13:00 on June 25 (Sun) is selected. When the user operates a determination button on the input device 6, the system image generating section 120 generates an event registration screen for the selected event, and the display processing section 118 displays the event registration screen on the output device 4.

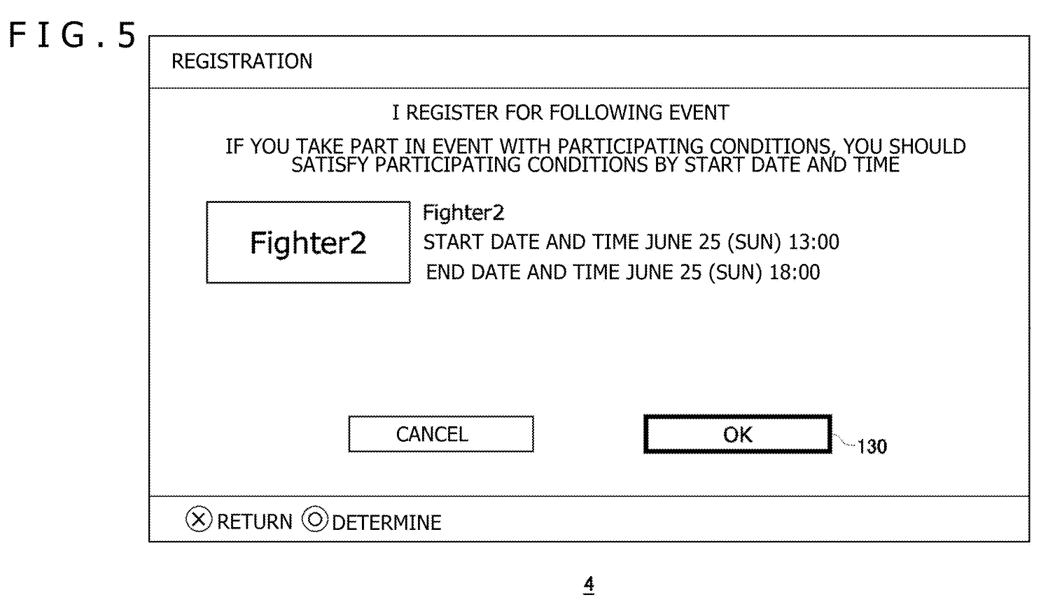

FIG. 5 illustrates an event registration screen by way of example. When the user aligns a focus frame 130 with an OK button on the event registration screen and operates the determination button on the input device 6, the transmission processing section 122 transmits registration information requesting a registration of participation in the game tournament to the server device 5. The registration information includes at least information (event ID (identification)) that identifies the game tournament that the user wishes to take part in and information (e.g., user account) that specifies the user. When the server device 5 accepts the registration information, the system image generating section 120 generates a registration completion image indicating that the participation registration is completed, and the display processing section 118 displays a registration completion screen on the output device 4.

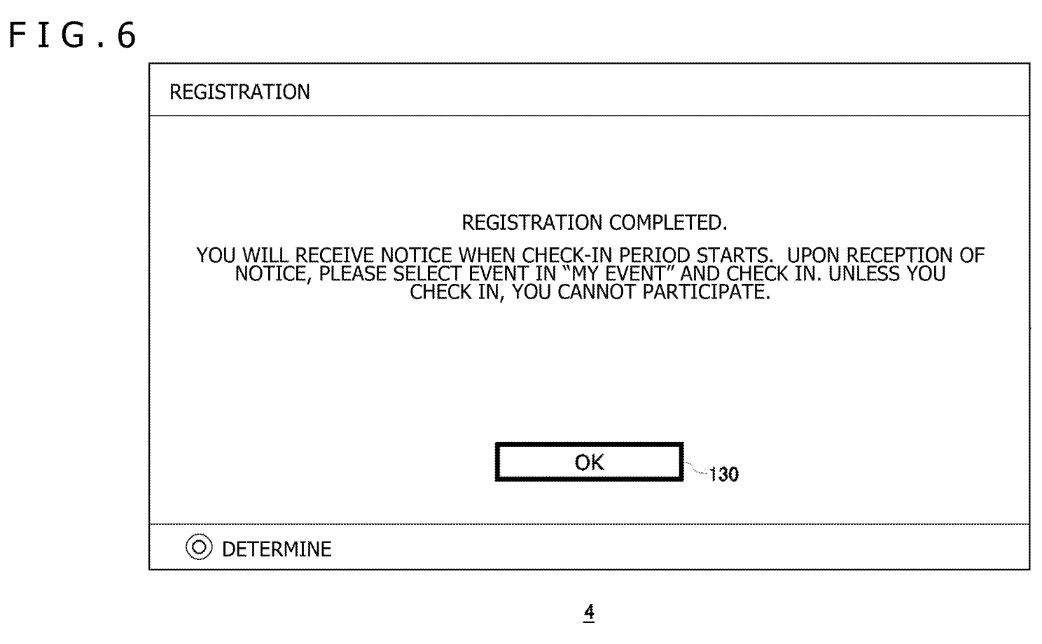

FIG. 6 illustrates a registration completion screen by way of example. When the user operates the determination button on the input device 6, the process of registering the participation in the event is completed.

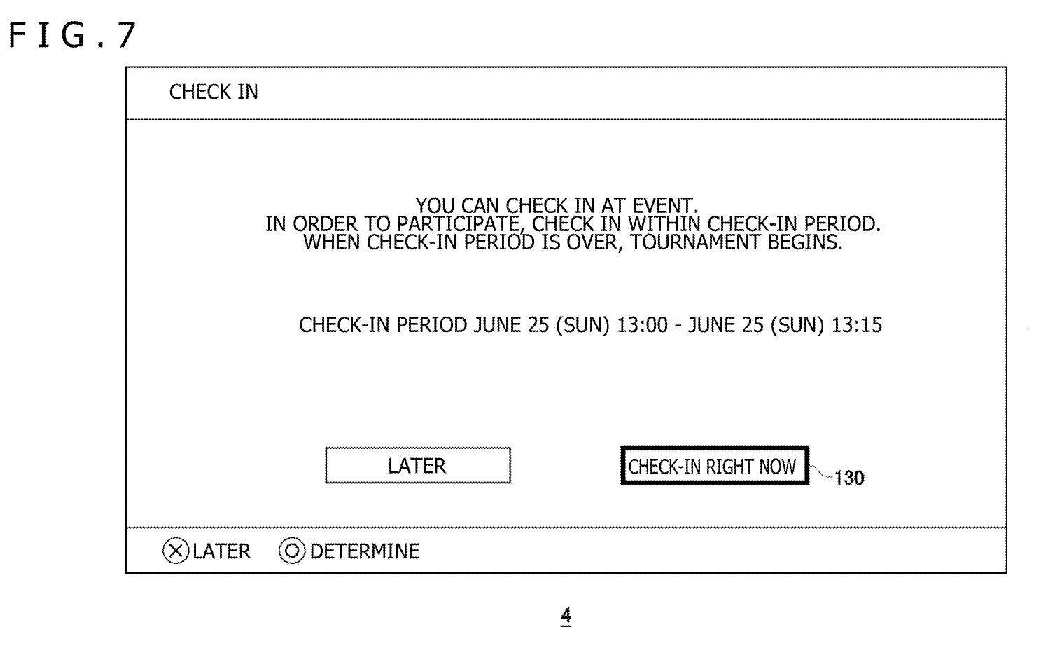

FIG. 7 illustrates a check-in screen by way of example. When a date and time has come to start a check-in, the display processing section 118 displays a check-in screen on the output device 4. When the user aligns the focus frame 130 with “CHECK IN RIGHT NOW” and operates the determination button on the input device 6, the transmission processing section 122 transmits participation information requesting a check-in at the game tournament to the server device 5. The participation information includes at least information (event ID) that identifies the game tournament that the user wishes to take part in and information (e.g., user account) that specifies the user. When the server device 5 accepts the participation information, the system image generating section 120 generates a check-in completion image indicating that the check-in is completed, and the display processing section 118 displays a check-in completion screen on the output device 4.

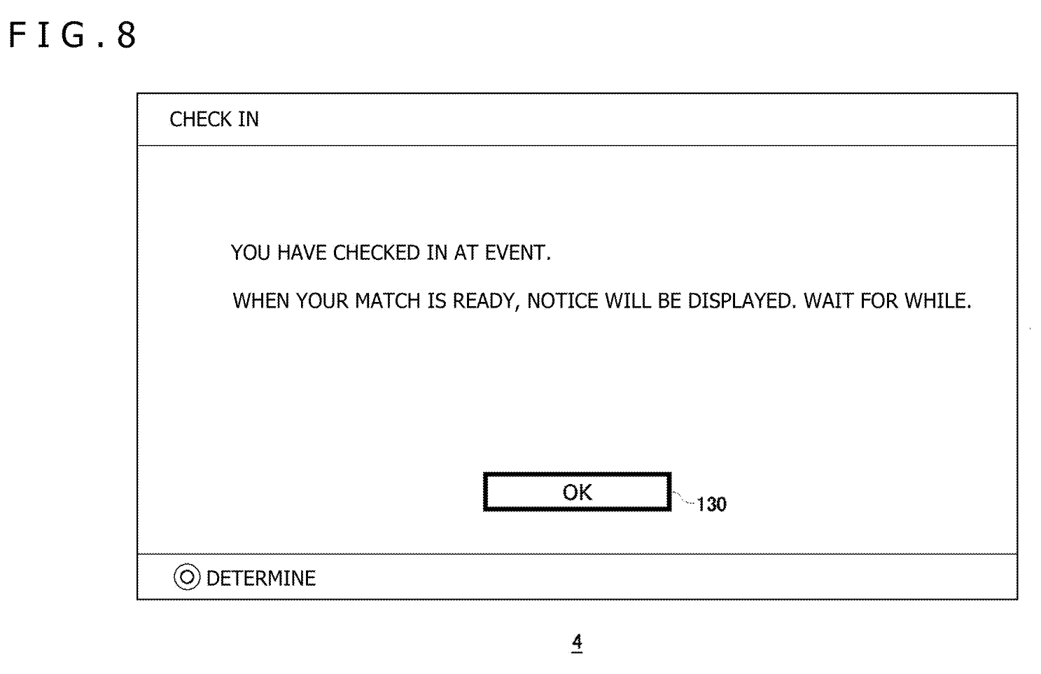

FIG. 8 illustrates a check-in completion screen by way of example. The user operates the determination button on the input device 6 and waits for the match to start.

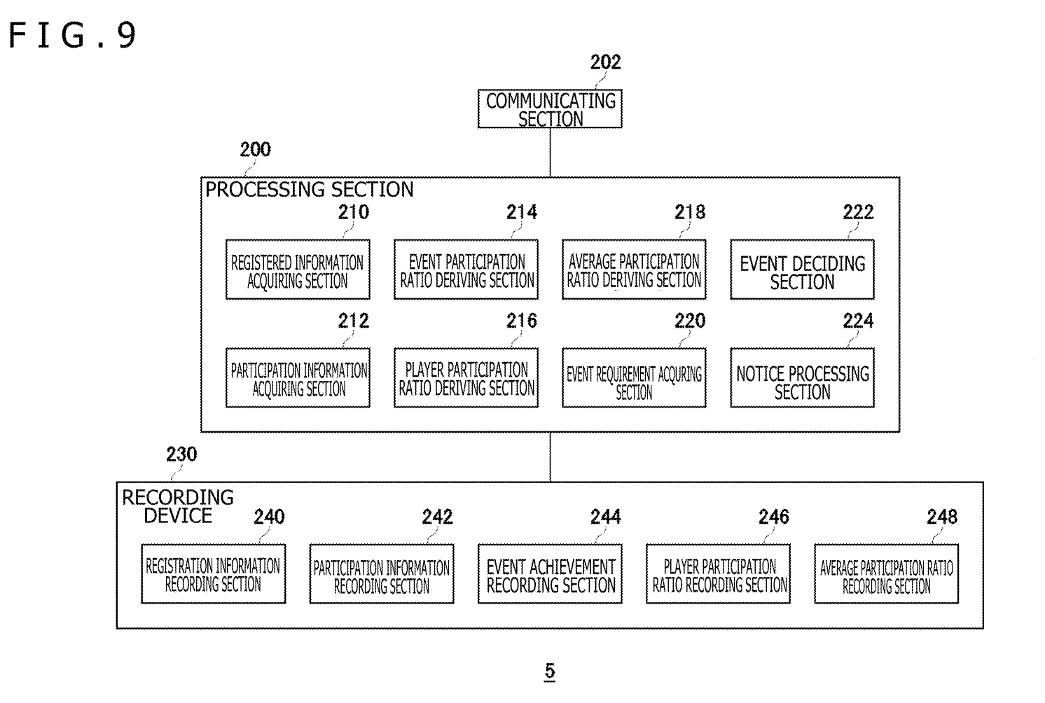

FIG. 9 illustrates functional blocks of the server device 5. The server device 5 includes a processing section 200, a communicating section 202, and a recording device 230. The processing section 200 includes a registration information acquiring section 210, a participation information acquiring section 212, an event participation ratio deriving section 214, a player participation ratio deriving section 216, an average participation ratio deriving section 218, an event requirement acquiring section 220, an event determining section 222, and a notice processing section 224. The recording device 230 includes a registration information recording section 240, a participation information recording section 242, an event performance recording section 244, a player participation ratio recording section 246, and an average participation ratio recording section 248.

The server device 5 includes a computer that realizes the various functions illustrated in FIG. 9 by executing programs. The computer includes a memory for being loaded with the programs, one or more processors for executing the programs, an auxiliary storage device, other LSIs, and the like, a hardware. The processor or processors are made up of a plurality of electronic circuits including semiconductor integrated circuits and LSIs. The electronic circuits may be mounted on one chip or a plurality of chips. The functional blocks illustrated in FIG. 9 are implemented by coordination between hardware and software, so that those skilled in the art is able to understand that these functional blocks can be implemented in various forms based on only hardware, only software, or their combination.

During a period for accepting participation in an event, the registration information acquiring section 210 acquires registration information including information specifying players that wish to take part in the event from a plurality of information processing devices 10. The registration information acquiring section 210 records the information specifying the players in the registration information recording section 240 in association with the event ID. After the end of the participation accepting period, the server device 5 generates a list of matches (e.g., a tournament bracket) representing competing pairs of the players recorded in the registration information recording section 240.

During a period for checking in at the event, the participation information acquiring section 212 acquires information including information specifying players that take part in the event from a plurality of information processing devices 10. The participation information acquiring section 212 records the information specifying the players in the participation information recording section 242 in association with the event ID.

According to the information processing system 1, events are held at various times. The registration information acquiring section 210 records information specifying players that have registered their participation in the registration information recording section 240 with regard to the respective events, and the participation information acquiring section 212 records information specifying players that have checked in (participated) in the participation information recording section 242 with regard to the respective events. Therefore, the registration information recording section 240 has recorded therein the information specifying the players that have registered their participation in the past events, whereas the participation information recording section 242 has recorded therein the information specifying the players that have actually participated in the past events.

After players have registered their participation in events, they may sometimes entirely forget the registration of their participation and may eventually cancel the events. Particularly, in the case of events that players can take part in for free, they are more likely to forget the existence of the events than paid events. Moreover, the longer the period of time after the registration of participation in an event until the date and time for starting the event is, the higher the possibility that the player will forget the existence of the event is. Providing a tournament bracket is produced at the end of a participation acceptance period, if many players do not subsequently check in, then there occur many matches where one of the competing pairs does not show up and many matches where both of the competing pairs fail to appear, with the result that the event looks desolate. The event organizer too finds the event problematic because investment efficiency is poor due to a low player participation ratio. According to the present embodiment, the server device 5 has a function to adjust the schedule of events in the future based on the performance of events in the past.

The event participation ratio deriving section 214 derives the number of players that have registered their participation in events in the past (the number of registered players) from information specifying the players that have registered their participation in the events in the past. Furthermore, the event participation ratio deriving section 214 derives the number of players that have actually participated in the events in the past (the number of participating players) from information specifying the players that have actually participated in the events in the past. The event participation ratio deriving section 214 then derives participation ratios of the events in the past using the number of registered players and the number of participating players.

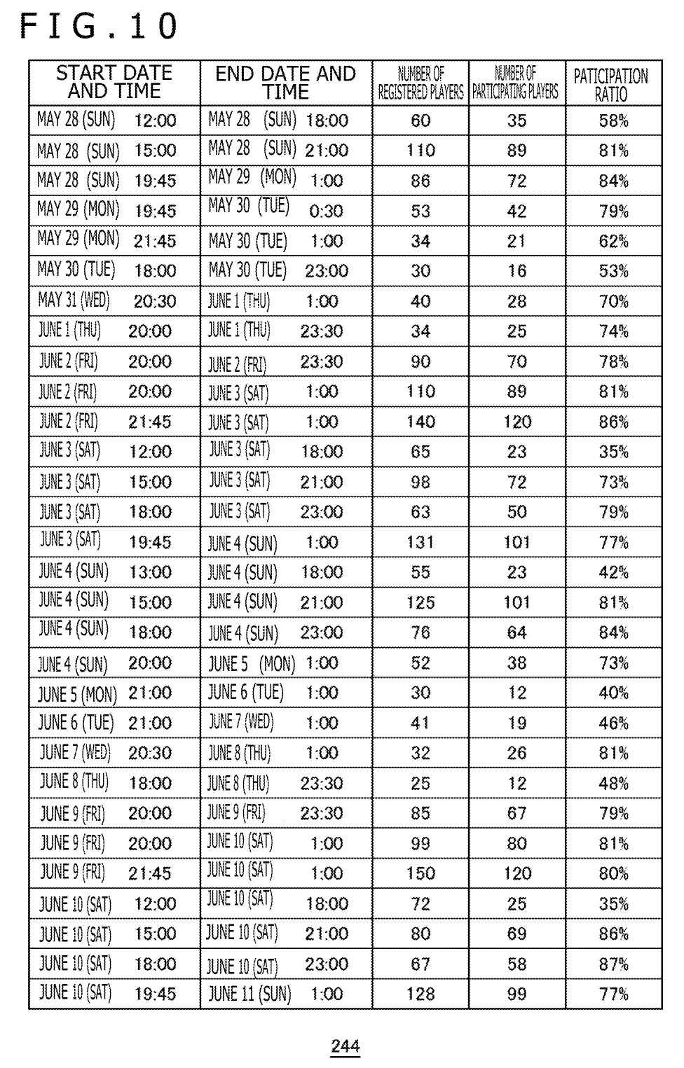

FIG. 10 illustrates, by way of example, participation ratios derived from the number of registered players and the number of participating players in events in the past. The event participation ratio deriving section 214 counts the numbers of players that have registered their participation in the events in the past (the numbers of registered players) from the information specifying the players that have registered their participation in the events in the past by referring to the contents recorded in the registration information recording section 240. In addition, the event participation ratio deriving section 214 counts the numbers of players that have actually participated in the events in the past (the numbers of participating players) from the information specifying the players that have actually participated in the same events in the past by referring to the contents recorded in the participation information recording section 242. The event participation ratio deriving section 214 then calculates participation ratios of the events in the past as (the number of participating players)/(the number of registered players).

The event participation ratio deriving section 214 derives participation ratios of all the events in the past. For example, at the end of each event, the event participation ratio deriving section 214 may derive a participation ratio of the event. The event participation ratio deriving section 214 records the number of registered players, the number of participating players, and the participation ratio of each event in the event performance recording section 244. The event performance recording section 244 has recorded therein the numbers of registered players, the numbers of participating players, and the participation ratios of the respective events together with the dates and times for starting and finishing the events and the game titles in association with the event IDs.

The player participation ratio deriving section 216 derives a participation ratio of each player by referring to the contents recorded in the registration information recording section 240 and the participation information recording section 242. The participation ratio of a player represents a probability that the player has actually taken part in (checked in) an event after having registered its participation in the event. For example, if a player has registered its participation in 10 events and taken part in 7 out of them, the participation ratio of the player is calculated as 70%, and if a player has registered its participation in 20 events and taken part in 5 out of them, the participation ratio of the player is calculated as 25%. The player participation ratio deriving section 216 records the participation ratios of players in the player participation ratio recording section 246 in association with the user accounts.

According to the embodiment, the event determining section 222 determines a date and time for holding an event in the future based on the participation ratios of the events in the past. The event determining section 222 may determine a date and time for holding an event in the future based on the dates and times for holding the events in the past whose participation ratios are high by referring to the contents recorded in the event performance recording section 244.

The average participation ratio deriving section 218 analyzes the participation ratios of the events in the past and specifies days of the week on which events with high participation ratios have been held and start times of those events. Though the average participation ratio deriving section 218 should preferably analyze the participation ratios of the events in the past per game title, if the number of the events in the past per game title is small, then the average participation ratio deriving section 218 may analyze the participation ratios of the events in the past per game genre. Here, game genres include a fighting type and a sport type, for example, among others. Since participating players are expected to have different attributes for different game genres, the average participation ratio deriving section 218 may analyze the participation ratios of the events in the past per game genre.

The average participation ratio deriving section 218 may average the participation ratios of those events that were held on the same days of the week and had the same start times, thereby calculating average participation ratios per day of the week on which the events were held and per start time thereof. Note that since a participation ratio is calculated according to the formula of (the number of participating players)/(the number of registered players), the level of confidence in participation ratios is low if the number of registered players small. Therefore, the average participation ratio deriving section 218 should preferably exclude the participation ratios of events whose registered players is equal to or smaller than a predetermined number from its averaging process (i.e., may ignore events whose registered players is small). Moreover, the average participation ratio deriving section 218 should preferably perform the averaging process while excluding participation ratio outliers. The average participation ratio deriving section 218 specifies days of the week on which events were held and start times thereof with high average participation ratios in descending order. The average participation ratio deriving section 218 may specify start times with high average participation ratios per day of the week. The average participation ratio deriving section 218 also derives an average number of participating players at each start time. The average participation ratio deriving section 218 records the derived average participation ratios and average numbers of participating players in the average participation ratio recording section 248 in association with the days of the week on which the events were held and the start times thereof.

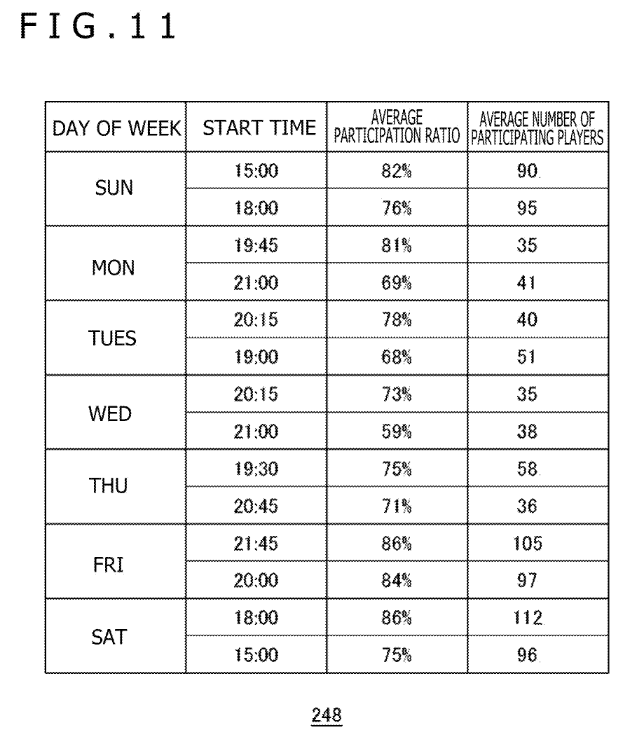

FIG. 11 illustrates, by way of example, start times of events whose average participation ratios are high. According to this example, the start times of two events whose average participation ratios are higher than the others per day of the week are illustrated.

The event requirement acquiring section 220 acquires event requirements from the event organizer, and the event determining section 222 determines dates and times for holding events in the future in a manner to satisfy the event requirements. The event requirements include at least a period during which to set events in the future and the number of times that the events are to be held. The period during which to set events in the future refers to a period in the future, e.g., a next week or a next month. The number of times that the events are to be held refers to the number of times that the events are to be held within the period. The event determining section 222 determines dates and times for holding as many events as the number of times that the events are to be held within the acquired period.

If the event requirement acquiring section 220 acquires event requirements that represent “next week” as the period and “twice” as the number of times that events are to be held, for example, then the event determining section 222 determines dates and times for holding two events next week based on the dates and times on which the events with high average participation ratios have been held. If the average participation ratios illustrated in FIG. 11 are recorded in the average participation ratio recording section 248, then inasmuch as the two average participation ratios of the events held on “Friday, start time 21:45” and “Saturday, start time 18:00” are the highest, the event determining section 222 may determine dates and times for holding two events as Friday, start time 21:45, next week and Saturday, start time 18:00 next week.

The event requirements may include a condition with regard to the holding of events. The event determining section 222 determines dates and times for holding as many events as the number of times that the events are to be held in a manner to satisfy the condition. For example, if the event requirement acquiring section 220 acquires event requirements representing “next week” as the period, “seven times” as the number of times that events are to be held, and “everyday” as the condition with regard to the holding of events, then the event determining section 222 determines dates and times for holding seven events next week based on the dates and times on which the events with highest average participation ratios have been held on each day of the week. If the average participation ratios illustrated in FIG. 11 are recorded in the average participation ratio recording section 248, then the event determining section 222 may determine the dates and times for holding seven events as Sunday 15:00 next week, Monday 19:45 next week, Tuesday 20:15 next week, Wednesday 20:15 next week, Thursday 19:30 next week, Friday 21:45 next week, and Saturday 18:00 next week.

For example, if the event requirement acquiring section 220 acquires event requirements representing “next week” as the period, “nine times” as the number of times that events are to be held, and “everyday” as the condition with regard to the holding of events, then the event determining section 222 determines dates and times for holding seven events next week based on the dates and times on which the events with highest average participation ratios have been held on each day of the week, and determines dates and times for holding two events next week based on the dates and times on which the events with high average participation ratios have been held, among the remaining dates and times on which the events are to be held. If the average participation ratios illustrated in FIG. 11 are recorded in the average participation ratio recording section 248, then the event determining section 222 may determine the dates and times for holding nine events as Sunday 15:00 next week, Sunday 18:00 next week, Monday 19:45 next week, Tuesday 20:15 next week, Wednesday 20:15 next week, Thursday 19:30 next week, Friday 20:00 next week, Friday 21:45 next week, and Saturday 18:00 next week.

The event requirements may include a condition with regard to rewards. The condition with regard to rewards includes the total amount of rewards that players participating in events receive. The event determining section 222 distributes rewards to each of a plurality of events. For example, if the event requirement acquiring section 220 acquires event requirements representing “next week” as the period, “seven times” as the number of times that events are to be held, “everyday” as the condition with regard to the holding of events, and “100 thousand points” as the total amount of rewards, then the event determining section 222 determines dates and times for holding seven events as Sunday 15:00 next week, Monday 19:45 next week, Tuesday 20:15 next week, Wednesday 20:15 next week, Thursday 19:30 next week, Friday 21:45 next week, and Saturday 18:00 next week, and distributes the rewards (100 thousand points) to each of the events. The points may be currency that can be used in the information processing system 1.

The event determining section 222 may distribute rewards to each of a plurality of events on the basis of the average participation ratios of the events. The event determining section 222 may distribute rewards such that the higher the average participation ratios in the past, the higher the distribution ratios of the rewards. This increases rewards for events where higher participation ratios are expected. Conversely, the event determining section 222 may distribute rewards such that the lower the average participation ratios in the past, the higher the distribution ratios of the rewards. Since events with lower average distribution ratios in the past are predicted to have lower participation ratios this time as well, it is expected that the participation ratios of players will be increased by setting rewards to a higher level.

Alternatively, the event determining section 222 may distribute rewards to each of a plurality of events on the basis of the numbers of players that actually took part in events in the past. According to the example illustrated in FIG. 11, the average numbers of participating players are calculated as follows.

Sunday 15:00, 90 players

Monday 19:45, 35 players

Tuesday 20:15, 40 players

Wednesday 20:15, 35 players

Thursday 19:30, 58 players

Friday 21:45, 105 players

Saturday 18:00, 112 players

The event determining section 222 may distribute 100 thousand points based on the proportions of average participating players according to the following formula.

Total amount of rewards for each day of the week = (average participating players on each day of the week) × (100 thousand points)/(the sum of average participating players on all days of the week)

Here, the sum of average participating players on all days of the week is 475 players. Therefore, the total amount of rewards for each day of the week is calculated as follows.

Sunday 15:00, 18.9 thousand points

Monday 19:45, 7.4 thousand points

Tuesday 20:15, 8.4 thousand points

Wednesday 20:15, 7.4 thousand points

Thursday 19:30, 12.2 thousand points

Friday 21:45, 22.1 thousand points

Saturday 18:00, 23.6 thousand points

As described above, the event determining section 222 is able to determine dates and times for holding events that are expected to have high participation ratios of players. With increased participation ratios, the event organizer finds the investment efficiency high, and the players can enjoy exciting tournaments.

The notice processing section 224 notifies the information processing device 10 of information representing the holding of events in the future that have been determined by the event determining section 222. At this time, the notice processing section 224 establishes lengths of periods during which to accept participations in events in the future on the basis of the participation ratios of players in the past recorded in the player participation ratio recording section 246. Specifically, the notice processing section 224 establishes longer participation acceptance periods for players with higher participation ratios and shorter participation acceptance periods for players with lower participation ratios. Therefore, the notice processing section 224 establishes a participation acceptance period for players with lower participation ratios only immediately before a date and time for starting an event. Players with lower participation ratios tend to forget the existence of an event if the period after they have registered their participation until they check (participate) in at the tournament is long. Consequently, the players with lower participation ratios are motivated to increase their participation ratios by allowing them to register their participation only immediately before the date and time for holding the event.

Therefore, the notice processing section 224 generates an event list based on the participation ratios of players in events in the past and provides the generated event list to the information processing device 10. In the information processing device 10, the event information acquiring section 116 acquires the event list generated on the basis of the participation ratios of users in events in the part, the system image generating section 120 generates an event selection image, and the display processing section 118 displays an event selection screen on the output device 4. The event selection screen illustrated in FIG. 4 displays the icons of events to be held within one week. However, the notice processing section 224 may generate an event list so as to display only icons of events to be held within two days for users with low participation ratios in the past.

The present disclosure has been described above according to its embodiment. The embodiment is illustrated by way of example and those skilled in the art should understand that the components and processing processes of the embodiment can be combined according to various modifications and the modifications fall within the scope of the present disclosure. According to the embodiment, the event participation ratio deriving section 214 derives participation ratios of events. However, the event participation ratio deriving section 214 may derive participation ratios of events in each of divided regions.

The present disclosure can be utilized as a technology for carrying out an event such as a game tournament.

1: Information processing system

5: Server device

10: Information processing device

100: Processing section

102: Communicating section

110: Accepting section

112: Game executing section

114: Game image generating section

116: Event information acquiring section

118: Display processing section

120: System image generating section

122: Transmission processing section

130: Focus frame

200: Processing section

202: Communicating section

210: Registration information acquiring section

212: Participation information acquiring section

214: Event participation ratio deriving section

216: Player participation ratio deriving section

218: Average participation ratio deriving section

220: Event requirement acquiring section

222: Event determining section

224: Notice processing section

230: Recording device

240: Registration information recording section

242: Participation information recording section

244: Event performance recording section

246: Player participation ratio recording section

248: Average participation ratio recording section

What is claimed is:

1. A server device comprising:
one or more processors having hardware, the one or more processors configured to:
derive participation ratios of past events based on numbers of players that registered for the past events and numbers of players that actually participated in the past events; and
determine one or more dates and times for future events based on the participation ratios of the past events.

2. The server device according to claim 1, wherein the one or more processors are configured to determine a date and a time of the future event based on dates and times of past events with high participation ratios.

3. The server device according to claim 1, wherein the one or more processors are configured to:
acquire a time frame and a number of one or more events to be held; and
determine the number of one or more dates and times for the number of one or more events within the acquired time frame.

4. The server device according to claim 3, wherein the one or more processors are configured to:
acquire a condition for holding the one or more events; and
determine the number of one or more dates and times for the number of one or more events that satisfy the condition.

5. The server device according to claim 1, wherein the one or more processors are configured to:
acquire a total amount of rewards that players participating in the one or more future events receive; and
distribute the rewards to each of a plurality of events.

6. The server device according to claim 5, wherein the one or more processors are configured to distribute the rewards to each of the plurality of events based on the participation ratios of the past events.

7. The server device according to claim 5, wherein the one or more processors are configured to distribute the rewards to each of the plurality of events based on the number of players that actually participated in the past events.

8. The server device according to claim 1, wherein the one or more processors set lengths of periods for accepting participations in the future events based on the participation ratios of the players in the past.

9. An information processing device comprising:
one or more processors having hardware, wherein the one or more processors are configured to:
acquire an event list generated based on participation ratios of a user in past events; and
display the acquired event list.

10. A method comprising:
deriving participation ratios of past events based on numbers of players that registered for the past events respectively and numbers of players that actually participated in the past events respectively; and
determining one or more dates and times for future events based on the participation ratios of the past events.
